(19) United States
(12) Patent Application Publication
(10) Pub. No.: US 2013/0029712 A1
(43) Pub. Date: Jan. 31, 2013

(54) DEVICE/SERVICE DISCOVERY AND CHANNEL ACCESS CONTROL FOR PROXIMITY DEVICE-TO-DEVICE WIRELESS COMMUNICATION

(71) Applicants: Huai-Rong SHAO, San Jose, CA (US); Chiu NGO, San Francisco, CA (US)

(72) Inventors: Huai-Rong SHAO, San Jose, CA (US); Chiu NGO, San Francisco, CA (US)

(73) Assignee: SAMSUNG ELECTRONICS CO., LTD., Suwon (KR)

(21) Appl. No.: 13/557,045

(22) Filed: Jul. 24, 2012

Related U.S. Application Data
(60) Provisional application No. 61/511,876, filed on Jul. 26, 2011.

(51) Int. Cl. H04W 48/10

(52) U.S. Cl. 455/515

(57) ABSTRACT

Embodiments of the invention relate to device/service discovery and channel access control for peer-to-peer wireless communication systems. One embodiment comprises communication in a wireless communication network, by monitoring one or more broadcast channels utilized by one or more wireless communication devices, and based on said monitoring, obtaining information related to said one or more wireless devices. Said communication further includes providing the obtained information to said one or more wireless communication devices for establishing device-to-device wireless communication between at least a pair of wireless communication devices. In one embodiment, the device-to-device wireless communication comprises device-to-device wireless communication between a pair of wireless communication devices in a proximity device-to-device network.

### CROSS-REFERENCE TO RELATED APPLICATION

This application claims priority benefit under 35 U.S.C. §119(e) of U.S. Provisional Patent Application Ser. No. 61/511,876, filed on Jul. 26, 2011, incorporated herein by reference.

### FIELD OF THE INVENTION

The present invention relates to proximity communication networks, and in particular to discovery and channel access in proximity communication networks.

### DESCRIPTION OF RELATED ART

Wireless communication networks have become common, wherein wireless communication devices such as mobile devices communicate with base stations using various communication protocols. Such wireless devices communicate with each other using one or more base stations of a wireless communication network. In other implementations of wireless communication, wireless devices communicate directly with nearby wireless devices, such as wireless devices in close proximity.

### BRIEF SUMMARY OF THE INVENTION

Embodiments of the invention relate to device/service discovery and channel access control for peer-to-peer wireless communication systems. One embodiment comprises communication in a wireless communication network, by monitoring one or more broadcast channels utilized by one or more wireless communication devices, and based on said monitoring, obtaining information related to said one or more wireless devices. Said communication further includes providing the obtained information to said one or more wireless communication devices for establishing device-to-device wireless communication between at least a pair of wireless communication devices.

In one embodiment, the device-to-device wireless communication comprises device-to-device wireless communication between a pair of wireless communication devices in a proximity device-to-device network.

In one embodiment, an agent module monitors one or more broadcast channels utilized by said one or more wireless devices to obtain information related to said one or more wireless devices. The agent module maintains said device information of the one or more wireless communication devices. The agent module automatically forwards a message from a wireless communication device to another wireless communication device. The agent module dynamically provides said device information to one or more wireless communication devices for establishing device-to-device wireless communication between at least a pair of wireless communication devices.

In one embodiment, a wireless communication device monitors one or more broadcast communication channels for information about a destination wireless communication device. If information about the destination wireless communication device is not detected, then the initiating wireless communication device transmits a discovery message on a broadcast channel. The initiating wireless communication device receives information about the destination wireless communication device for establishing device-to-device wireless communication between the initiating and destination wireless communication devices.

In one embodiment, a wireless communication device monitors one or more broadcast communication channels a broadcast channel having sufficient available bandwidth for communication. The wireless communication device initiates transmitting a service advertisement message on a broadcast channel. The initiating wireless communication device receives information in response to the service advertisement message, for establishing device-to-device wireless communication between the initiating and a destination wireless communication device.

These and other features, aspects and advantages of the present invention will become understood with reference to the following description, appended claims and accompanying figures.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a diagram illustrating a system architecture that implements a communication system, according to an embodiment of the invention.

FIG. 2 shows a flowchart of a communication control process for device/service discovery, according to an embodiment of the invention.

FIG. 3 shows a flowchart of a communication control process for service advertisement process, according to an embodiment of the invention.

FIG. 3A shows a flowchart of an example agent function process, according to an embodiment of the invention.

FIG. 4 shows a functional block diagram of a wireless communication device in FIG. 1, according to an embodiment of the invention.

FIG. 5 shows a functional block diagram of an agent device in FIG. 1, according to an embodiment of the invention.

FIG. 6 is a high level block diagram showing an information processing system comprising a computer system useful for implementing an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

Embodiments of device/service discovery and channel access control for peer-to-peer wireless communication systems, are disclosed herein. An embodiment of the invention allows scalability for device/service discovery and channel access control in wireless peer-to-peer communication. An implementation of such peer-to-peer communication is in wireless device-to-device (D2D) communication for high-speed data transfer applications in mobile devices and data terminals (e.g., Long Term Evolution (LTE) industry standard). An example of such a D2D communication is in proximity device-to-device communication, such as in a proximity device-to-device network (PDDN). PDDN allows communication devices to communication with each other directly without an access point or base station within a certain proximity.

Proximity D2D communication allows low-cost and direct connections for devices in a proximity area (e.g., within about 1.5 kilometers) such as a residential community, a shopping mall, a school campus, a high-density commercial city area and a stadium. Proximity D2D communication according to embodiments of the invention is complimentary to existing networks such as cellular networks, cable and Internet services. Examples of proximity D2D communication applications and services include local advertising an information sharing (e.g., coupons from neighborhood stores, garage sales, individuals people offering services, community activity announcement), social networking (e.g., peer-to-peer multiplayer mobile gaming, finding people that share common interests), personal cloud (e.g., remotely obtaining information and controlling nearby devices, integrated sensor networks), etc.

An embodiment of the present invention achieves low latency and low power performance in wireless proximity D2D communication. An embodiment of the present invention provides an architecture and protocol for device/service discovery, service advertisement and channel access control for proximity D2D communication. In one embodiment, the proximity range is similar to that applicable in IEEE 802.11 WiFi local area networks. In another embodiment, cellular communication such as CDMA, WCDMA, GSM, UMTS, 3G, 4G, WiMAX, LTE. According to an embodiment of the invention, a cell-boundary-less and scalable hybrid proximity D2D communication architecture employs a device and agent combined hybrid architecture. Based on said architecture, embodiments of the invention provide scalable device/service discovery, a service advertisement and communication channel access control protocols.

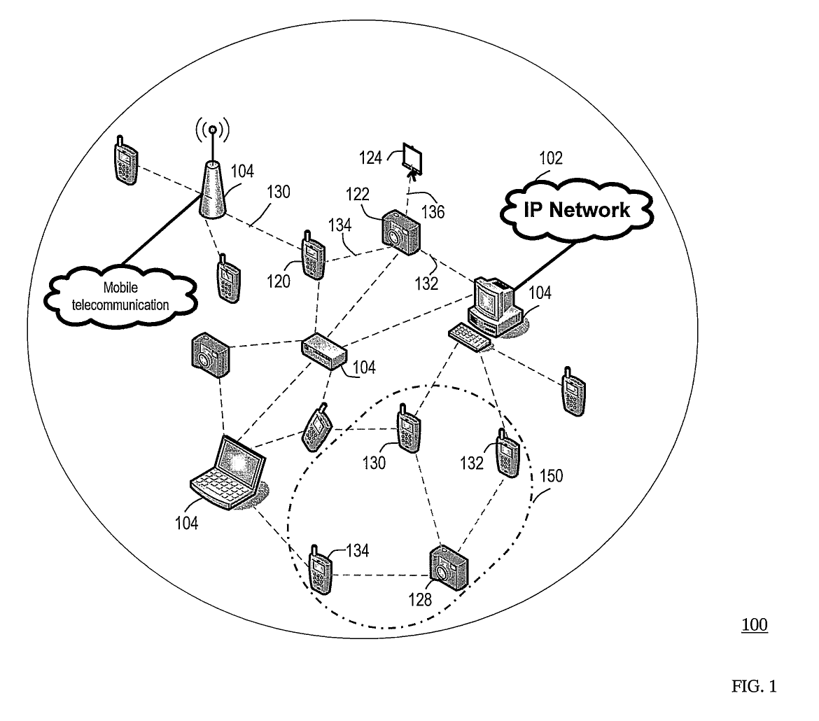

FIG. 1 shows a diagram illustrating a system architecture that implements a communication system 100, according to an embodiment of the invention. In FIG. 1, the dashed lines between devices indicate wireless communication, and the solid lines between devices indicate wireless communication. According to an embodiment of the invention, the system 100 implements a semi-coordinated and asynchronous proximity D2D communication architecture and protocol. The architecture is FIG. 1 is configured as cell-boundary-less and scalable hybrid proximity D2D communication architecture, according to an embodiment of the invention.

The system 100 includes one or more agents 104, wherein in one example an agent 104 comprises a base station connected to network components such as a base station controller (not shown) which in turn is coupled to a gateway (not shown). The gateway provides access to such as a private core network or a wide area public network, such as the Internet (i.e., IP network) 102. These particular network components may vary depending on the implementation of the wireless communication network (e.g., CDMA vs. GSM)). The base station controller may also be coupled to a mobile switching center (not shown) or other wireless communication network element.

The system 100 further includes wireless communication devices comprising wireless devices 120, 122 and 124. The wireless devices 120 through 124 are illustrative of many different types of conventional wireless communication devices capable of communicating with a base station 104.

As illustrated in FIG. 1, the wireless device 122 communicates with an agent 104 via a wireless network communication link 132. The wireless device 120 communicates with a base station 104 via a wireless network communication link 130. In addition, the wireless devices 120 and 122 (in proximity with each other) may communicate directly with each other via direct communication link 134 (i.e., D2D communication). Further, the wireless devices 124 and 122 (in proximity with each other) can communicate directly with each other via a short-range wireless communication link 136.

### Hybrid Architecture

The system 100 provides a device and agent combined hybrid architecture. An agent can be a base station, an access point (AP), or another mainly powered device such as a PC, a server or a laptop. In some cases, an agent can be a battery powered device such as a laptop or cellular phone which can help other devices such as low power sensors for D2D network operation. Different from infrastructure mode, a wireless device in the D2D architecture of the system 100 does not closely tie up with an agent (e.g., a base station or access point), according to an embodiment of the invention. The cell-boundary-less architecture avoids complicated handover issues in communication systems that employ infrastructure-based communication architecture.

In one embodiment of the invention, the function of an agent includes: storing information about nearby wireless devices, forwarding information from one nearby wireless device to one or more other nearby wireless devices, responding to messages (e.g., device/service discovery messages, service advertisement messages) from one or more wireless devices, etc.

The proximity D2D communication architecture is open and cell-boundary-less (i.e., no cell boundary limitation), and wireless devices can move freely without a communication handover procedure, according to an embodiment of the invention. In one embodiment, a wireless device can dynamically receive information from one or more nearby collaborative agents in establishing direct communications with other wireless devices. In one embodiment, the nearby range is similar to that applicable in IEEE 802.11 WiFi networks. In another embodiment, nearby range is similar to that applicable to cellular communication such as CDMA, WCDMA, GSM, UMTS, 3G, 4G, WiMAX. In one embodiment the D2D architecture is overlapped and complimentary to any existing networks such as cellular, WiFi network (wireless radio frequency), and wired Internet backbone networks. In addition, the D2D architecture is information and service centric in which end users (human beings and machines) can easily exchange information and advertise/request services, therebetween.

### Device/Service Discovery

According to an embodiment of the invention, the system 100 is configured to provide improved and low-power device/service discovery, utilizing a scalable broadcasting channel protocol in which the wireless devices on a current broadcast channel announce the use of the next broadcast channel if the current broadcast channel is heavily utilized. In addition, a collaborative agent stores information about nearby wireless devices to speed up device discovery processing, wherein a nearby collaborative agent automatically forwards a discovery request from a wireless device to another wireless device.

In one embodiment, the system 100 is configured for a scalable broadcast channel assignment protocol for device/service discovery to reduce discovery latency. A wireless device typically scans wireless radio frequency channels to find one or more target wireless devices. There are two conventional channel scanning approaches for wireless device discovery. In a first channel scanning approach, wireless device scans all channels in a passive or active manner. This approach may cause a long latency if the number of channels to scan is large. In addition, this approach cannot avoid deadlock issue for device discovery. In a second channel scanning approach, a wireless device only scans a default channel or several pre-defined default discovery channels. This approach has scalability issues if the number of wireless devices is large because one or more default channels may not be able to accommodate broadcasting traffic from many wireless devices.

In one embodiment the present invention provides a scalable broadcast channel assignment approach for device discovery. In one implementation, the number of broadcast channels employed for discovery and service advertisement is dynamically adjusted based on the number of wireless devices and traffic load on the used broadcast channels.

In one embodiment, according to a scalable broadcast channel protocol, wireless devices initially attempt to use a first broadcast channel for scanning in discovery and service advertisement. If a wireless device detects that a pre-defined percentage of channel time (e.g., about 70%) is being used for transmission traffic by other wireless devices, it means the first broadcast channel is heavily utilized. When the current broadcast channel reaches heavily utilization, the wireless devices utilizing the current broadcast channel announce a second broadcast channel, wherein when newcomer wireless devices scan the first broadcast channel the newcomer wireless devices are informed to use the second broadcast channel to transmit discovery or service advertisement information.

If the second broadcast channel becomes heavily utilized, a third broadcast channel is utilized using a similar process, and so on. Using a scalable broadcast channel assignment protocol according to an embodiment of the invention, a wireless device can quickly detect target devices or services without randomly scanning all channels which can also cause device searching deadlocks.

According to an embodiment of the invention, to further speedup the discovery process, an agent obtains and maintains information about nearby wireless devices. The agent monitors a current broadcast channel used by wireless devices, and stores wireless device configuration and state information from nearby wireless devices based on information transmitted on the monitored broadcast channel.

For example, the agent stores information about nearby wireless devices when they incur state or configuration changes, such as a new wireless device joining or leaving a proximity D2D network. Using stored information for nearby wireless devices, the agent can quickly reply to a discovery request from a first nearby wireless device when a second nearby wireless device which is the target of the discovery request cannot detect the discovery request.

The agent maintains information relating to status/configuration of the target wireless device, such as when the target wireless device is in standby mode, or when the target wireless device has switched to a private transaction channel, etc., and therefore cannot detect the discovery request. The agent utilizes such stored information to reply to the discovery request from the first wireless device with relevant information.

According to an embodiment of the invention, a device/service discovery process reduces power consumption for mobile wireless devices and other low power wireless devices. For example, after detecting a discovery request message from a nearby mobile wireless device, an agent can automatically forward the discovery request message such that the mobile wireless device need not re-transmit the discovery request message.

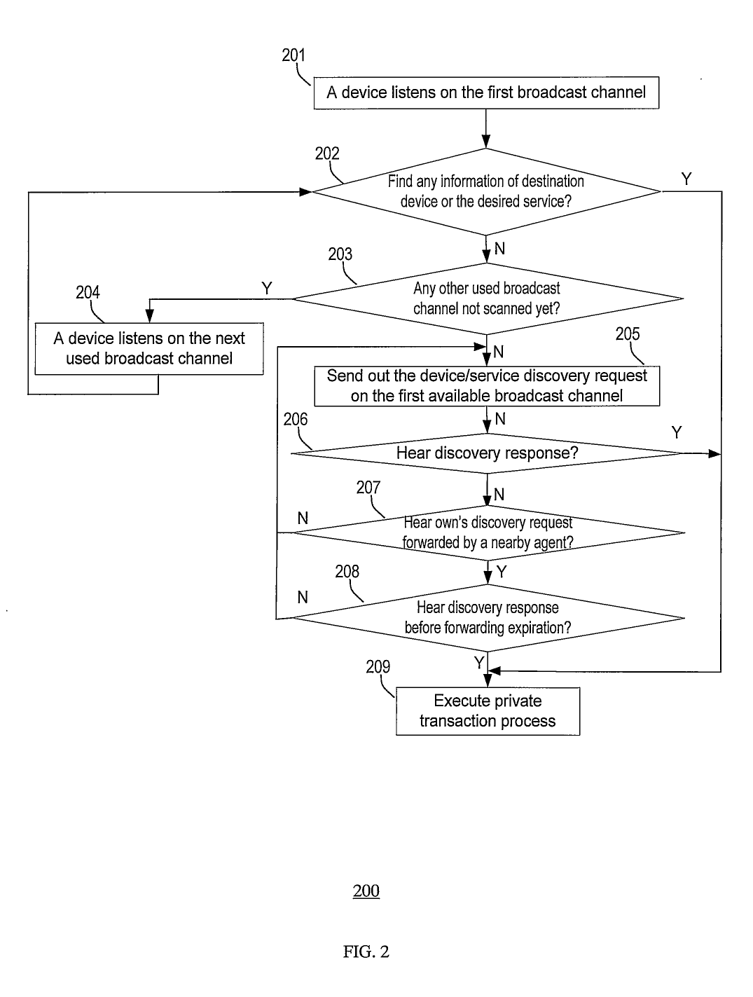

FIG. 2 shows an example of the device/service discovery process 200 based on the hybrid proximity D2D communication architecture in FIG. 1, according to an embodiment of the invention. Process block 201 comprises a first wireless device (e.g., initiating device) listening on a first broadcast channel. Process block 202 comprises determining if any information is found about a destination (target) device or the desired service. If yes, the process proceeds to process block 209, otherwise in process block 203 it is determined if any other broadcast channels in use have not been scanned yet. If yes, the process proceeds to process block 204, otherwise the process proceeds to process block 205.

Process block 204 comprises the first wireless device listening (scanning) on a next broadcast channel in use, and proceeding back to process block 202. Process block 205 comprises the first wireless device transmitting out a device/service discovery request on a first available broadcast channel.

Process block 206 comprises determining if a response to the discovery request is received. If yes, the process proceeds to process block 209, otherwise in process block 207 it is determined if the first wireless device receives its own discovery request as forwarded by a nearby agent. If not, the process proceeds back to process block 205, otherwise in process block 208 it is determined if a discovery request response is received at the first wireless device before a forwarding timeout expiration. If not, the process proceeds back to process block 205, otherwise in process bock 209 a private transaction process is conducted between the first wireless device and the responding destination device by a direct wireless D2D communication between first wireless device and the responding destination device as a proximity device-to-device network.

Variations in the device/discovery process are also possible, according to embodiments of the invention. For example, after one or more wireless devices leave a broadcast channel by sending departure announcement messages, the broadcast channel may have free channel time/bandwidth to accommodate newcomer wireless devices. The freed channel time/bandwidth may be used to move some traffic and wireless devices from other wireless channels. For example, if after an operation time, the first broadcast channel is lightly used but still other wireless devices use the second broadcast channel, the wireless devices on the second broadcast wireless channel may move to the first channel by a channel switching procedure to reduce the discovery time for newcomer devices.

### Service Advertisement

According to an embodiment of the invention, the system 100 implements a reduced power service advertisement protocol. A wireless device advertises its services through a proximity device-to-device network. Similar to discovery procedure, a wireless device that wants to advertise its services, attempts to send out service advertisement message on a first broadcast channel. If the first broadcast channel is not available, then wireless device utilizes a second channel, and so on. In addition, a nearby agent helps forward such service advertisement messages to other wireless devices.

In one implementation, a wireless devices use a first available broadcast channel to transmit service advertisement information. A nearby collaborative agent receiving the service advertisement automatically forwards the service advertisement from a sending wireless device to another wireless device.

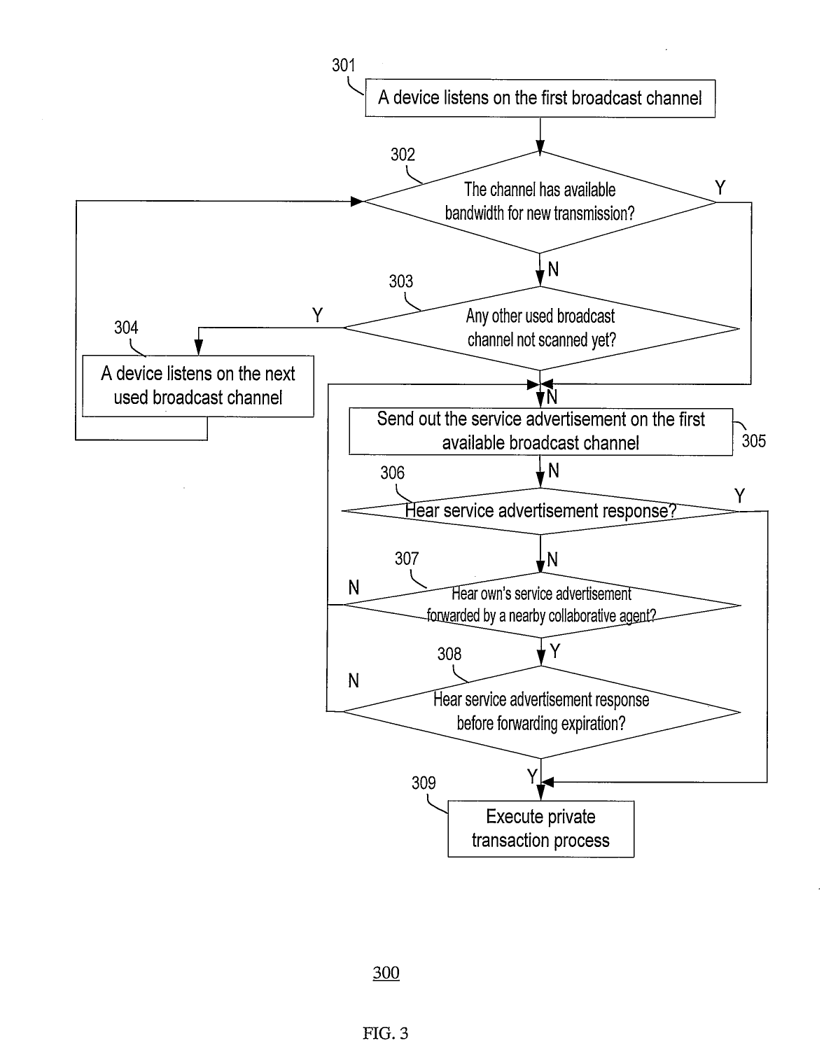

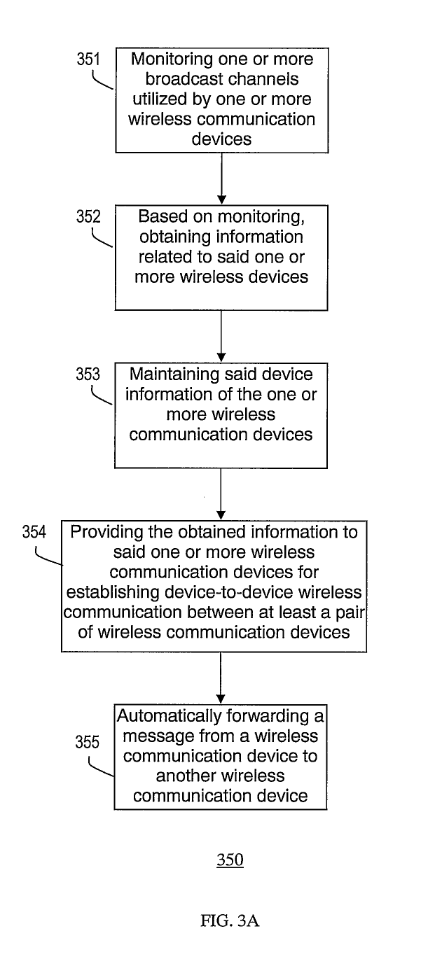

FIG. 3 shows an example of service advertisement process 300 based on the hybrid proximity D2D communication architecture in FIG. 1, according to an embodiment of the invention. Process block 301 comprises a first wireless device listening on a first broadcast channel.

Process block 302 comprises determining if the channel has available bandwidth for new transmission. If yes, the process proceeds to process block 305, otherwise in process block 303 it is determined if any other broadcast channels in use have not been scanned yet. If yes, the process proceeds to process block 304, otherwise the process proceeds to process block 305.

Process block 304 comprises the first wireless device listening (scanning) on a next broadcast channel in use, and proceeding back to process block 302. Process block 305 comprises the first wireless device transmitting out a service advertisement on a first available broadcast channel.

Process block 306 comprises determining if a response to the service advertisement response is received. If yes, the process proceeds to process block 309, otherwise in process block 307 it is determined if the first wireless device receives its own service advertisement as forwarded by a nearby agent. If not, the process proceeds back to process block 305, otherwise in process block 308 it is determined if a service advertisement response is received at the first wireless device before a forwarding timeout expiration. If not, the process proceeds back to process block 305, otherwise in process bock 309 a private transaction process is conducted between the first wireless device and the responding destination device by a direct wireless D2D communication between the first wireless device and the responding destination device as a proximity device-to-device network.

Variations in the service advertisement process are also possible, according to embodiments of the invention. For example, instead of directly sending service advertisement messages from a wireless device, the wireless device may search for a nearby collaborative agent first. If the wireless device can find a nearby collaborative agent, then the wireless device registers with the agent for the service advertisement information through a private transaction process with the agent. Thereafter, the agent can broadcast the service advertisement information to other wireless devices within the D2D communication network.

### Semi-Coordinated Channel Access Control

According to an embodiment of the invention, the system 100 is further configured for a semi-coordinated channel access protocol for open broadcasting, group communication and one-to-one communication services. In one implementation, when a wireless device wants to start sending out broadcast information (broadcast message) on a channel, the wireless device senses on the channel for a certain time period. If the channel is clear during that time period, then the wireless device sends out broadcast information in a packet on the channel. The packet carrying the broadcast information includes the desired time of the next transmission of the same information.

If a nearby agent receives the packet, the agent stores the received information in the packet and may append the information in its own packet for its own next transmission. When the wireless device receives the same broadcast information it sent out, from a nearby forwarding agent, the wireless device ceases re-transmitting of that broadcast information to save power.

If the wireless device receives said broadcast information forwarded by multiple nearby agents, the wireless device may send out another broadcast message on the channel to indicate which agent the wireless device grants information forwarding permission to (usually based on the signal strength levels received from the agents). An agent can decide not to forward broadcast information from a nearby wireless device if the agent already has queued a selected quantity of received broadcast information to be forwarded. Or, the agent may drop certain existing queued broadcast information in order to include newly received broadcast information to forward.

According to an embodiment of the invention, after device/service discovery between two wireless devices, the two wireless devices can enter into a private transaction process using a proximity device-to-device network model. The private D2D transaction process can still use the same channel as that used for discovery if sufficient bandwidth remains available on the channel. In one embodiment, the two wireless devices utilize Request to Send (RTS) and Confirm to Send (CTS) protocols for transmit information to each other on the channel. The two wireless devices may also negotiate to switch to another channel if they detect that more than a pre-defined percentage of channel time (e.g., about 70%) is being used for transmission by other wireless devices.

For more than two wireless devices in a private transaction process for group communication applications, the wireless devices use a virtual round robin method to access the selected wireless channel for D2D communication between a pair of wireless devices at a time. The wireless devices define packet transmission order based on the time for each wireless device joining the group.

For example, in the system 100 of FIG. 1, if wireless device 128 initiates a group 150 and then wireless device 130, 132, and 134 join the group one by one, then wireless device 128 sends out a packet first, wireless device 130 can only send out a packet after receiving a packet from wireless device 128. Similarly, wireless device 132 sends out a packet first and wireless device 134 can only send out a packet after receiving a packet from wireless device 132, as so on in a round robin fashion. After wireless device 134 sends out a packet, the transmission right on the channel is handed back to wireless device 128. If a wireless device in the group has no information to send, that wireless device send out a small dummy packet to notify the next wireless device in the round robin model.

If a wireless device in the group abruptly departs the group without following a group departure process, then after a timeout period a next wireless device in the group replace the place of the departing wireless device in the round robin model.

As noted, the function of an agent includes: storing information about nearby wireless devices, forwarding information from one nearby wireless device to one or more other nearby wireless devices, responding to messages (e.g., device/service discovery messages, service advertisement messages) from one or more wireless devices, etc. FIG. 3A shows a flowchart of an example agent function process 350, according to an embodiment of the invention. Process block 351 comprises the agent monitoring one or more broadcast channels utilized by one or more wireless communication devices.

Process block 352 comprises, based on said monitoring, the agent obtaining information related to said one or more wireless devices. In one embodiment, the agent monitors one or more broadcast channels utilized by one or more wireless devices to obtain device information including device configuration and state information for said one or more wireless devices.

Process block 353 comprises the agent maintaining said device information of the one or more wireless communication devices. Process block 354 comprises, providing the obtained information to said one or more wireless communication devices for establishing device-to-device wireless communication between at least a pair of wireless communication devices. Process block 355 comprises the agent automatically forwarding a message from a wireless communication device to another wireless communication device.

### Synchronous and Asynchronous Operation

Embodiments of the invention are useful for both synchronized and un-synchronized operation among wireless devices within a proximity D2D communication network. In one embodiment, synchronized operation means that the communication devices are synchronized in clock and coordinated by a common time structure for access to a communication channel (e.g., fixed time-slot based transmission by scheduling in advance). Un-synchronized operation means the devices may not be synchronized in clock and access to the communication channel in a more random manner.

### Ad-Hoc Architecture

According to an embodiment of the invention, the hybrid D2D communication architecture in the communication system 100 of FIG. 1 can turn into a pure ad-hoc architecture mode if no agent 104 is present for proximity device-to-device network communication. For the pure ad-hoc architecture mode, peer devices can also perform function of agent, for example, storing or forward information from other nearby wireless devices. An alternative solution is that a peer device may not store or forward information from other devices. In this case, the functions that an agent involves will be removed from device/service discovery, service advertisement and channel access control procedures.

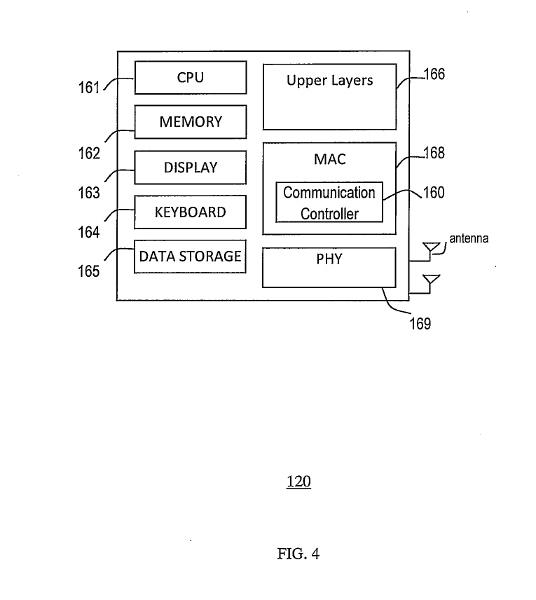

FIG. 4 shows a block diagram of one of the wireless communication devices, such as wireless device 120, illustrated in FIG. 1. The wireless device 120 includes a processing circuit such as a central processing unit (CPU) 161, memory device 162, display device 163, keyboard 164, data storage 165, and multiple protocol. The protocol entities include upper layers 166, Medium Access Control (MAC) 168 and Physical Layer (PHY) 169. In one embodiment, for a cellular communication, the upper layers 166 comprise Packet Data Convergence Protocol (PDCP) and Radio Link Control (RLC). In another embodiment, for WiFi communication, the upper layers 166 comprise Logical Link Control (LLC) and network layer (e.g., IP layer). In one embodiment, the upper layers 166 include both communication layers for device-to-device communication in a local area network and a cellular network.

In one embodiment, IP packets are transported through said multiple protocol entities wherein PDCP provides functions including IP header compression and ciphering and integrity protection of transmitted data. RLC provides functions including segmentation/concatenation, retransmission handling and in-sequence delivery to higher layers. MAC provides functions including transmission uplink and downlink scheduling. PHY provides coding/decoding, modulation/demodulation (OFDM), multi-antenna mapping and other typical physical layer functions.

The wireless device 120 further includes a wireless device communication controller module 160 which implements the functions of the wireless communication devices disclosed herein, including device/service discovery, service advertisement, channel access control, packetization and data transmission, according to embodiments of the invention. Although in the example shown in FIG. 4 the functions of the device communication controller module 160 is implemented in the MAC layer 168, such functions can be implemented in other layers in the wireless device 120 such as PHY layer directly or through RLC layer, according to embodiments of the invention.

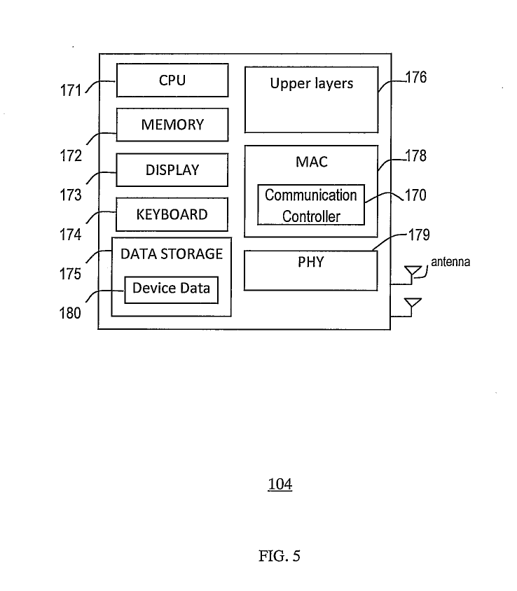

FIG. 5 shows a block diagram of one of the agent devices 104 illustrated in FIG. 1. An agent device 104 includes a processing circuit such as a central processing unit (CPU) 171, memory device 172, display device 173, keyboard 174, data storage 175, and multiple protocol. The protocol entities include upper layers 176, Medium Access Control (MAC) 178 and Physical Layer (PHY) 179. In one embodiment, for a cellular communication, the upper layers 176 comprise Packet Data Convergence Protocol (PDCP) and Radio Link Control (RLC). In another embodiment, for WiFi communication, the upper layers 176 comprise Logical Link Control (LLC) and network layer (e.g., IP layer). In one embodiment, the upper layers 176 include both communication layers for device-to-device communication in a local area network and a cellular network.

The wireless device further includes an agent device communication controller module 170 which implements the agent functions disclosed herein, including storing information about nearby wireless devices, forwarding information from one nearby wireless device to one or more other nearby wireless devices, responding to messages (e.g., device/service discovery messages, service advertisement messages) and data packet forwarding from one or more wireless devices. In one example, the agent communication controller module 170 maintains information about one or more nearby wireless devices 120 as device 180 in the data storage module 175.

Although in the example shown in FIG. 5 the functions of the agent device communication controller module 170 is implemented in the MAC layer 178, such functions can be implemented in other layers in the agent device 104 such as PHY layer directly or RLC layer, according to embodiments of the invention. Further, an agent device 104 can be a wired device, a wireless device, or combination thereof.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

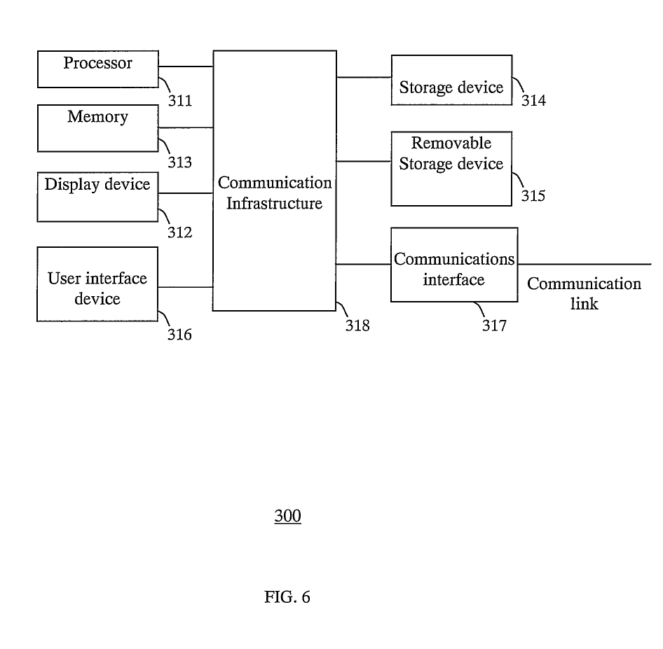

FIG. 6 is a high level block diagram showing an information processing system comprising a computer system 300 useful for implementing an embodiment of the present invention. The computer system 300 includes one or more processors 311, and can further include an electronic display device 312 (for displaying graphics, text, and other data), a main memory 313 (e.g., random access memory (RAM)), storage device 314 (e.g., hard disk drive), removable storage device 315 (e.g., removable storage drive, removable memory module, a magnetic tape drive, optical disk drive, computer readable medium having stored therein computer software and/or data), user interface device 316 (e.g., keyboard, touch screen, keypad, pointing device), and a communication interface 317 (e.g., modem, a network interface (such as an Ethernet card), a communications port, or a PCMCIA slot and card). The communication interface 317 allows software and data to be transferred between the computer system and external devices. The system 300 further includes a communications infrastructure 318 (e.g., a communications bus, cross-over bar, or network) to which the aforementioned devices/modules 311 through 317 are connected.

Information transferred via communications interface 317 may be in the form of signals such as electronic, electromagnetic, optical, or other signals capable of being received by communications interface 317, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor and/or multi-core processor to perform the features of the computer system. Such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A method for communication in a wireless communication network, comprising:
monitoring one or more broadcast channels utilized by one or more wireless communication devices;
based on said monitoring, obtaining information related to said one or more wireless devices; and
providing the obtained information to said one or more wireless communication devices for establishing direct device-to-device wireless communication between at least a pair of wireless communication devices over a wireless communication channel.

2. The method of claim 1, wherein:
the device-to-device wireless communication comprises device-to-device wireless communication between a pair of wireless communication devices in a proximity device-to-device network.

3. The method of claim 2, further comprising:
an agent module monitoring one or more broadcast channels utilized by said one or more wireless devices to obtain information related to said one or more wireless devices.

4. The method of claim 3, further comprising:
the agent module monitoring one or more broadcast channels utilized by one or more wireless devices to obtain device information including device configuration and state information for said one or more wireless devices; and
the agent module maintaining said device information of the one or more wireless communication devices.

5. The method of claim 4, further comprising:
the agent module dynamically providing said device information to one or more wireless communication devices for establishing device-to-device wireless communication between at least a pair of wireless communication devices.

6. The method of claim 3, further comprising:
the agent module monitoring messages transmitted by said one or more wireless communication devices on one or more broadcast channels utilized by one or more wireless devices; and
the agent module automatically forwarding a message from a wireless communication device to another wireless communication device.

7. The method of claim 1, further comprising:
a wireless communication device monitoring one or more broadcast communication channels for information about a destination wireless communication device;
if information about the destination wireless communication device is not detected, then the initiating wireless communication device transmitting a discovery message on a broadcast channel; and
the initiating wireless communication device receiving information about the destination wireless communication device for establishing direct device-to-device wireless communication between the initiating and destination wireless communication devices.

8. The method of claim 7, further comprising:
the initiating wireless communication device receiving information about the destination wireless communication device from an agent module, for establishing device-to-device wireless communication between the initiating and destination wireless communication devices.

9. The method of claim 7, further comprising:
the initiating wireless communication device re-retransmitting a discovery message until the initiating wireless communication device receives a response about the destination wireless communication device.

10. The method of claim 1, further comprising:
a wireless communication device monitoring one or more broadcast communication channels for a broadcast channel having sufficient available bandwidth for communication;
the monitoring wireless communication device initiates transmitting a service advertisement message on a broadcast channel; and
the initiating wireless communication device receiving information in response to the service advertisement message, for establishing direct device-to-device wireless communication between the initiating and a destination wireless communication device.

11. The method of claim 10, further comprising:
the initiating wireless communication device receiving information in response to the service advertisement message from an agent module, for establishing device-to-device wireless communication between the initiating an destination wireless communication device.

12. A wireless communication station for communication in a wireless communication system, comprising:
a controller that monitors one or more broadcast communication channels for detecting information about a destination wireless communication device; and
a physical layer (PHY) for communicating information over a wireless communication channel;
wherein if information about the destination wireless communication device is not detected, the controller initiates transmitting a discovery message on a broadcast channel; and
wherein upon the wireless communication station receiving information about the destination wireless communication device, the controller establishes direct device-to-device wireless communication between the wireless communication station and the destination wireless communication device over a wireless communication channel.

13. The wireless communication station of claim 12, wherein:
upon the controller receiving information about the destination wireless communication device from an agent module, the controller establishes direct device-to-device wireless communication between the wireless communication station and the destination wireless communication device.

14. The wireless communication station of claim 12, wherein:
the controller re-retransmits a discovery message until the wireless communication station receives a response about the destination wireless communication device.

15. The wireless communication station of claim 12, wherein:
the controller monitors one or more broadcast communication channels for a broadcast channel having sufficient available bandwidth for communication; and
the controller initiates transmitting a service advertisement message on a broadcast channel.

16. The wireless communication station of claim 15, wherein:
upon the wireless communication station receiving information in response to the service advertisement message from the destination device, the controller establishes direct device-to-device wireless communication between the initiating wireless communication station and the destination wireless communication device.

17. The wireless communication station of claim 15, wherein:
upon the wireless communication station receiving information in response to the service advertisement message from an agent module, the controller establishes direct device-to-device wireless communication between the initiating wireless communication station and the destination wireless communication device.

18. A wireless communication system, comprising:
multiple wireless communication devices; and
an agent device configured monitoring one or more broadcast channels utilized by one or more wireless communication devices, and based on said monitoring, obtaining information related to said one or more wireless devices, wherein the agent device provides the obtained information to said one or more wireless communication devices for establishing direct device-to-device wireless communication between a group of said wireless communication devices over a wireless communication channel.

19. The system of claim 18, wherein:
the device-to-device wireless communication comprises device-to-device wireless communication between a pair of wireless communication devices in a proximity device-to-device network.

20. The system of claim 19, wherein:
an agent module monitoring one or more broadcast channels utilized by said one or more wireless devices to obtain information related to said one or more wireless devices.

21. The system of claim 20, wherein:
the agent device monitors one or more broadcast channels utilized by one or more wireless devices to obtain device information including device configuration and state information for said one or more wireless devices; and
the agent device maintains said device information of the one or more wireless communication devices.

22. The system of claim 21, wherein:
the agent device dynamically provides said device information to one or more wireless communication devices for establishing device-to-device wireless communication between at least a pair of wireless communication devices.

23. The system of claim 20, wherein:
the agent device monitors messages transmitted by said one or more wireless communication devices on one or more broadcast channels utilized by one or more wireless devices; and
the agent device automatically forwards a message from a wireless communication device to another wireless communication device.

24. The system of claim 18, wherein:
an initiating wireless communication device monitors one or more broadcast communication channels for information about a destination wireless communication device;
if information about the destination wireless communication device is not detected, then the initiating wireless communication device transmits a discovery message on a broadcast channel; and
upon the initiating wireless communication device receiving information about the destination wireless communication device, the initiating wireless communication device establishing direct device-to-device wireless communication between the initiating and destination wireless communication devices.

25. The system of claim 24, wherein:
the initiating wireless communication device receives information about the destination wireless communication device from the agent device, for establishing device-to-device wireless communication between the initiating and destination wireless communication devices.

26. The system of claim 24, wherein:
the initiating wireless communication device re-retransmits a discovery message until the initiating wireless communication device receives a response about the destination wireless communication device.

27. The system of claim 18, wherein:
a wireless communication device monitors one or more broadcast communication channels for a broadcast channel having sufficient available bandwidth for communication;
the wireless communication device initiates transmitting a service advertisement message on a broadcast channel; and
the initiating wireless communication device receives information in response to the service advertisement message, for establishing direct device-to-device wireless communication between the initiating and a destination wireless communication device.

28. The system of claim 18, wherein:
the initiating wireless communication device receives information in response to the service advertisement message from the agent device, for establishing device-to-device wireless communication between the initiating and destination wireless communication device.

29. The system of claim 18, wherein the wireless device-to-device communication between said group of wireless communication devices comprises wireless communication in a local area network established between the group of wireless communication devices.

30. The system of claim 18, wherein the wireless device-to-device communication between said group of wireless communication devices comprises wireless communication in a cellular network established between the group of wireless communication devices.

31. The system of claim 18, wherein said group of wireless communication devices comprises three or more wireless communication devices which perform direct device-to-device communication between each pair of wireless communication devices in the group by accessing a wireless channel in a round robin manner.

32. The system of claim 18, wherein the agent device comprises a wireless agent device capable of communication over a wireless channel.
